(19) United States
(12) Patent Application Publication
(10) Pub. No.: US 2011/0126813 A1
(43) Pub. Date: Jun. 2, 2011

(54) MULTI-WIRE WAFER CUTTING APPARATUS AND METHOD

(75) Inventors: John B. Hodsden, Colorado Springs, CO (US); Kerry R. Lindemann, Scottsdale, AZ (US); Kerry L. Shaklee, Brighton, CO (US); Earl James Crawford, III, Colfax, CA (US)

(73) Assignee: Diamond Wire Technology, Inc., Baar (CH)

(21) Appl. No.: 12/628,816

(22) Filed: Dec. 1, 2009

(51) Int. Cl. B28D 1/08; B24B 1/00

(52) U.S. Cl. 125/16.02

(57) ABSTRACT

A multi-wire slurry-free wafer cutting apparatus along with a method for optimizing saw operation is disclosed that includes a cutting wire impregnated with a plurality of cutting particles wrapped multiple times around two or more wire guides to form a multi-wire web. A drive mechanism drives the web across an ingot at an optimum speed determined by setting a multi-wire web speed to an initial speed, detecting vibration of the web, identifying the web speed having a lowest vibration, and operating the drive mechanism at that speed as optimum. A cleansing fluid is applied to the multi-wire web that includes a major portion of water and a minor portion of surfactant which cleans the cutting wire and keeps the cut particles free of oxidation. One or more cleansing fluid applicators are configured to apply the cleansing fluid to the multi-wire web close to the ingot in a laminar flow.

### FIELD OF THE DISCLOSURE

This disclosure relates generally to multi-wire saws and more particularly to a slurry free multi-wire saw.

### BACKGROUND

Generally there is one type of multi-wire saw that can be used to cut an ingot, or block, of semiconductor material such as silicon into wafers with either a loose abrasive system, termed a slurry system, or with a fixed abrasive wire. The thickness of the semiconductor wafers is generally not a critical feature in integrated circuit device manufacture. Of primary importance is the surface structure of such a semiconductor wafer used as a substrate for integrated circuits. Wafer thickness is, however, of major importance in photovoltaic semiconductor applications, such as substrates for solar cell applications. In photovoltaic applications the wafer thickness and thickness variation as well as surface smoothness and flatness are very important design and fabrication considerations. As solar cell design has become more mature and sophisticated, the demand for thinner wafers used in these photovoltaic applications has increased dramatically.

Therefore there is a clear demand for ultrathin silicon (or other semiconductor material) wafers. Slurry saws have traditionally been used to cut such wafers. However, the silicon material cost is substantial, and therefore thinner and thinner wafers are desired, in order to reduce the cost and increase the yield. As a result, the spacing between cutting wires in the wire webs in these saws used to cut the silicon ingots or bricks into the wafers has continually been reduced. However, as saw manufacturers have struggled to meet this demand for wafer cutting saws that can cut thinner and thinner wafers, they have been met with complaints of broken wafers, wafer thickness variations, wafer surface roughness, etc. In addition, the use of silicon carbide, a known carcinogen, as a cutting agent along with ethylene glycol as the cutting medium, presents additional environmental hazards which must be dealt with, and recycling of materials and fluids involved in such operations is expensive.

A slurry saw takes cutting particles such as silicon carbide and suspends them in a relatively high viscosity fluid such as ethylene glycol, to form the slurry. As a wire is moved toward the surface of an ingot or brick of semiconductor material, the slurry, because of its viscosity, tends to adhere to the surface of the wire. As the wire passes over and into the ingot, the slurry is pulled along with the wire. The particles in the slurry on the wire cut into the ingot, forming a kerf or cutting width. As the wire exits the kerf, the slurry eventually drops or is scraped off of the wire.

Since the slurry is quite viscous, surface tension of the slurry on the wires is high. As the wires, arranged in a web of parallel wires traveling in the same direction, approach the ingot, this surface tension tends to pull adjacent wires within the web together before reaching the wire kerfs in the ingot. Among other things, this results in broken wafers, chips, and some wafers being thicker while others are thinner, a problem known as the “thick-thin” problem.

As can be imagined, this is a slow process for cutting, and the consistency of the slurry mixture has to be well controlled to avoid waviness, inconsistent thickness, scratching or other quality problems in the cut wafers.

One solution that has been used with some success is utilization of a slurry free saw and, in particular, a multi-wire saw using a fixed abrasive wire, like diamond wire, in conjunction with ethylene glycol as a cleansing fluid to clear silicon particles from the saw kerfs. The use of slurry free and in particular diamond (fixed abrasive) wire multi-wire saws has permitted the speed of cutting silicon wafers to be dramatically increased. However, the use of viscous cleansing fluid, i.e. ethylene glycol, remains an environmental hazard problem, a quality problem in the cut wafers, and also a cost problem for the user.

The application of water as a cleansing fluid effectively washes silicon particles from the saw kerfs and eliminates the potential environmental problems of using ethylene glycol, as well as its quality problems and high cost. However, water has some drawbacks. First, water inherently has an abundance of oxygen in it. Silicon particles tend to oxidize very rapidly in the presence of oxygen, thus forming SiO₂ on the surface of the particles, which effectively renders the particles non-recyclable. Second, water inherently has surface tension. This surface tension tends to pull adjacent wires in the cutting wire web close together, creating a “thick-thin” problem.

Currently the production demand is for wafers having a thickness on the order of around 160-200 microns. These are ultrathin wafers. Typical wafers used for photovoltaic or solar applications are most often somewhat square and typically have dimensions of 125 mm×125 mm or 156 mm×156 mm. Typical mono-crystalline silicon ingots, when formed, are about two meters long. Each ingot is then typically cropped into shorter sections. The ingot sections from which the wafers are cut are preferably about 18 inches in length while multi-silicon ingot bricks may be as long, but are more likely between about 10-15 inches in length. Again, as the demand for thinner and thinner wafers for photovoltaic applications has risen, an unacceptably high number of broken wafers, chipped wafers, and wafers with uneven thicknesses has again been experienced by users of slurry and slurry free saws.

It has been postulated that the cause of broken ultrathin wafers is due to the cantilever supported wafer portions formed by the kerfs during sawing vibrating excessively such that excessive lateral forces are being generated in the wafers vibrating as they are being formed, thus precipitating wafer breakage. One solution has been to cut an initial set of kerfs in an ingot, stop the saw, and adhesively bond a strip of material over the top edge of the wafers being cut, thus holding them apart in fixed position while the remainder of the ingot is being cut through. While this approach has addressed the perceived problem of excessive wafer vibration during cutting, it is time consuming to implement, and thus impractical from a production standpoint.

Another problem in the wafer cutting industry is the disposition of silicon byproducts. Silicon particles are very reactive, as mentioned above. Silicon has a strong affinity for oxygen. It wants to combine with oxygen and form SiO₂. Once SiO₂ is formed, even an extremely thin coating of SiO₂ on a silicon particle, the silicon cannot be practically extracted for reuse. A further problem with silicon particles is that they tend to adhere to some metals such as nickel, and agglomerate on the gaps between the teeth of diamond impregnated wire in the wire saw when diamond wire is used as the cutting agent.

While the slurry in a slurry saw removes heat from the wire and the work piece during cutting, slurry-free wire saws do not inherently have a means to remove heat from the kerfs created during cutting. Hence, slurry-free wire saws can benefit from use of a lubricating fluid. At the same time, this fluid can wash away or remove particles from the cutting wire created during the cutting process. Due to their small size the particles tend to stick to the cutting wire. If not removed, the particles degrade the quality of cuts, and by inducing web vibration the particles increase the chance of ingot structural failure. For instance, particles on the cutting wire can scratch the surface of the wafers being cut. As a consequence, secondary operations may be needed once the wafers are separated in order to remove the scratches. Particles on the cutting wire may also cause “wire jump.” This is a phenomenon wherein particles on the cutting wire cause the cutting wire to vibrate to such an extent that the cutting wire jumps from a wire groove on one of the rotatable wire guides into an adjacent wire groove. This can lead to ingot structural failure as well as a “thick-thin” effect (where adjacent wafers have larger and thinner thicknesses than the spacing between wire grooves).

To avoid the problems associated with particles sticking to the cutting wire, a water based lubricant may be applied to the multi-wire web in order to rinse or remove the particles from the cutting wire.

In the case of a slurry free saw using water instead of ethylene glycol to flush Si particles from the kerfs, there is an abundance of oxygen in the cleansing fluid. Therefore SiO₂ virtually immediately forms on the silicon particles rendering the silicon non-recyclable. If one uses ethylene glycol as the cleansing fluid to avoid the oxidation problem, then the surface tension issues become prominent because of higher viscosity, and the high viscosity of the ethylene glycol results in a poor job of cleansing, making the silicon particles stick to the wire, causing a reduction in the wire's cutting ability.

Therefore there is a need for a solution which addresses the “thick-thin” problem, prevents excessive chip formations, and precludes excessive wafer breakage, and adequately cleanses the diamond wire during operation of slurry-free multi-wire saws. Further, there is a clear need for mechanisms to reduce the environmental impact of such sawing operations, e.g. recycling of the materials such as silicon while solving the thick-thin and vibration related problems.

### SUMMARY OF THE DISCLOSURE

The present disclosure provides an optimal set of solutions to the problems identified above as well as providing some additional advantages. The solutions described below can be utilized singularly, but are most effectively utilized together. The first of these solutions is optimizing the speed at which a multi-wire wafer cutting apparatus is driven. Reduced vibrations decrease the chances that a semiconductor ingot will break while being cut into wafers.

It has been found that the running wire web acts like plucked musical instrument strings. Each of the wires in the web spanning between the guide rollers vibrates. Surprisingly the collective vibration amplitude is substantially independent of wire tension. Instead, the vibration amplitude varies with the wire speed, but does not do so linearly. The optimum saw operation occurs when the wire speed is set to minimize these vibrations and minimize the vibration amplitude. Detection of web vibration amplitude is determined by monitoring wire web vibration at various saw speeds with an electromagnetic vibration sensor.

The optimum speed can be determined by setting a multi-wire web speed to a first speed and detecting vibration of the multi-wire web. From these vibrations, vibration data can be generated, stored in a computer memory, and the process repeated for a plurality of multi-wire web speeds. The data is then evaluated to determine speed versus vibration amplitude. The multi-wire web speed at with the lowest vibration is observed is identified and then the drive mechanism may be driven at this speed. The vibrations in the wire web are preferably determined using an inductive vibration detector positioned adjacent the multi-wire web. The detector may also be connected to a computer which is configured to analyze the amplitude data. One vibration detector is known as a Humbucker. The Humbucker is used here in a completely new and different way than it is conventionally used as a guitar or other stringed instrument pickup.

The multi-wire saw apparatus for simultaneously cutting a plurality of wafers from an ingot in accordance with this disclosure has two or more rotatable wire guides, a cutting wire forming a multi-wire web spanning the wire guides, a drive mechanism coupled to the multi-wire web, a cleansing fluid containing a surfactant for coating silicon particles as they are cut from the ingot, and one or more cleansing fluid applicators. The multi-wire web includes those portions of the cutting wire that span between two of the two or more rotatable wire guides. The cutting wire may be impregnated with a plurality of cutting particles (e.g., diamond). The cleansing fluid can include a major portion of water and a minor portion of surfactant. While the multi-wire web cuts the plurality of wafers from the semiconductor ingot, or brick, the one or more cleansing fluid applicators applies the cleansing fluid to the multi-wire web preferably within about a 2 cm distance or less from the semiconductor ingot. In one embodiment, this distance is less than 1.5 cm. In another embodiment, this distance is less than 1.0 cm. The cleansing fluid applicators can include tapered ramps which provide a laminar flow of cleansing fluid onto the wires in the wire web.

The cleansing fluid may include one or more agents selected from the following: a surfactant, an anti-foaming agent, a defoaming agent, an anti-corrosive agent, and a biocide. Along with one or more of these agents, the cleansing fluid may also include a wetting agent. Primarily the cleansing fluid includes a surfactant which coats any semiconductor (silicon) particles ejected from the kerf before the particles have an opportunity to stick to the wire and to react with any free oxygen in the cleansing fluid. The particles so covered with the surfactant may then be recycled. A recycling device may then collect the cleansing fluid along with the semiconductor particles in the cleansing fluid and separate the particles from the fluid. The recycled fresh cleansing fluid may then be returned to the cleansing fluid applicators for reuse and the separated semiconductor particles may be reclaimed for further processing into ingots.

To achieve optimal operation of the multi-wire wafer cutting apparatus in accordance with the present disclosure, the apparatus should be operated at a wire drive speed that minimizes wire vibration, should include a cleansing fluid that has a surfactant to coat the silicon particles before they have an opportunity to stick to the cutting wire and combine with free oxygen in the cleansing fluid, and the cleansing fluid should be applied to the wire web at a close enough distance from the ingot sufficient to minimize surface tension interference from the cleansing fluid interaction between adjacent wires in the wire web and spaced sufficiently from the ingot to ensure sufficient wetting of the wires prior to wire entry into the ingot kerf.

One method for determining the optimal operating speed in accordance with the disclosure includes running a multi-wire web at a first speed, detecting vibrations in the multi-wire web at the first speed and storing the vibrations, running the multi-wire web at a second speed, and detecting vibrations in the multi-wire web at the second speed and storing the vibrations. These steps may be repeated for a plurality of speeds. The stored vibrations are then evaluated and assessed. The multi-wire web speed having the lowest vibration amplitude is then identified as the speed for saw operation.

More specifically, this method may include (a) setting a multi-wire web speed to a first multi-wire web speed, (b) detecting vibration amplitude in the multi-wire web using a vibration detector positioned in proximity to a portion of the multi-wire web, (c) generating vibration amplitude data from the detected vibration amplitude of the multi-wire web, (d) storing the vibration amplitude data, (e) repeating the setting, detecting, generating and storing operations for a plurality of multi-wire web speeds, (f) assessing the vibration amplitude data for each of the plurality of multi-wire web speeds, and (g) identifying the multi-wire web speed having the lowest vibration amplitude. In an embodiment, the vibration detector may inductively detect vibrations in the multi-wire web.

Various ones of the inventive aspects, approaches, and embodiments described above may be combined to yield various useful systems, methods, and apparatus for optimizing the speed that a multi-wire wafer cutting apparatus is driven at.

### BRIEF DESCRIPTION OF THE DRAWINGS

FIG. 1 illustrates portions of an exemplary embodiment of a wafer cutting apparatus configured to simultaneously cut a plurality of wafers from a semiconductor ingot or brick.

FIG. 2 is an enlarged view of one of the rotatable wire guides and portions of the multi-wire web shown in FIG. 1.

FIG. 3 schematically illustrates a simplified overhead view of a portion of the wafer cutting apparatus of FIG. 1 showing a first rotatable wire guide, a cleansing fluid applicator, a region where the cleansing fluid falls on the multi-wire web, a multi-wire web, and a semiconductor ingot that is to be cut into wafers.

FIG. 4 illustrates a simplified side view of the portion of the wafer cutting apparatus shown in FIG. 3.

FIGS. 5 and 6 illustrate simplified side and front views, respectively, of one exemplary embodiment of a cleansing fluid applicator used in the apparatus shown in FIG. 1.

FIG. 7 illustrates a simplified detail view of a portion of the wafer cutting apparatus of FIG. 1 showing a vibration detector positioned at a distance Y from the multi-wire web.

FIGS. 8, 9, and 10 are simplified partial plan views of the multi-wire web portion of the wafer cutting apparatus as in FIG. 1 showing the vibration detector positioned at front, middle, and back positions with respect to the wire web, respectively.

FIG. 11 illustrates a simplified detail view of a portion of an embodiment of a wafer cutting apparatus including a cleansing fluid collector used in the apparatus shown in FIG. 1.

FIG. 12 is a representative process flow diagram an exemplary method for determining the optimal speed of operation for a wafer cutting apparatus in accordance with the present disclosure.

### DETAILED DESCRIPTION

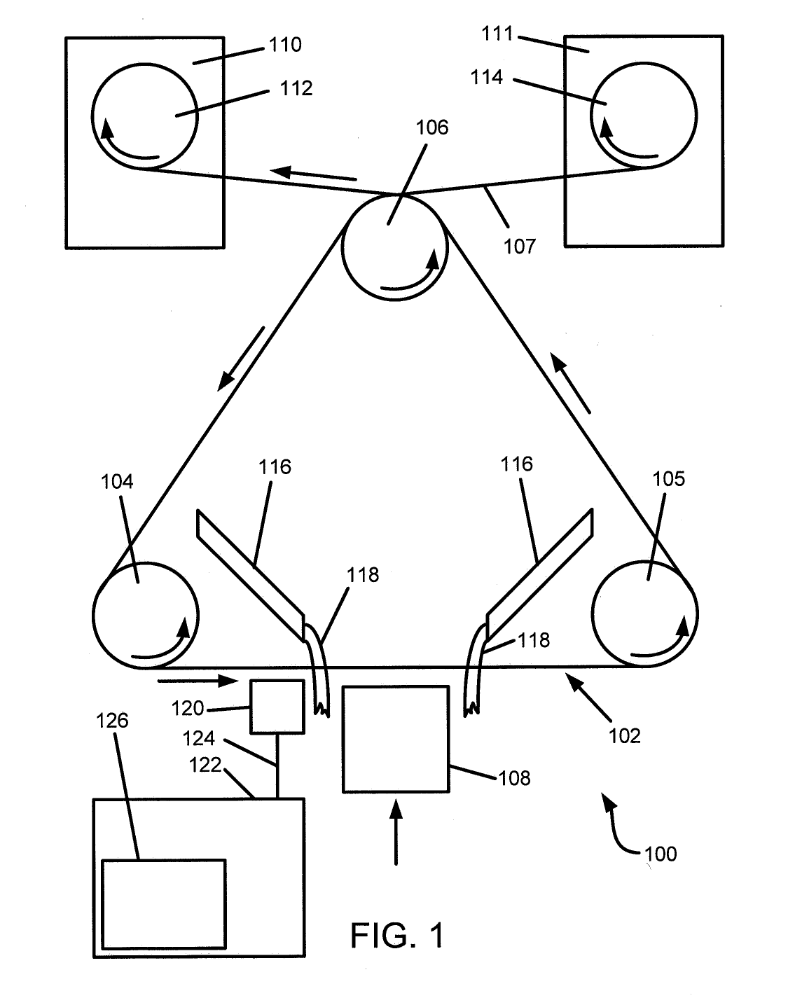

FIG. 1 is a simplified schematic of an exemplary embodiment of a wafer cutting apparatus 100 in accordance with the present disclosure. The apparatus 100 is configured to simultaneously cut a plurality of wafers from an ingot, block or brick 108 of semiconductor material such as silicon particularly for use in photovoltaic cell applications. The term “ingot” will be used in the description below for the sake of simplicity of explanation and not by way of limitation.

The wafer cutting apparatus 100 includes two or more (in this example, three) rotatable wire guides 104, 105, and 106 rotatably mounted on a conventional multi-wire saw frame (not shown for simplicity of explanation). Wrapped around and spanning the first, second, and third rotatable wire guides 104, 105, and 106 many times is a cutting wire 107. The cutting wire 107 in this exemplary embodiment is impregnated with a plurality of cutting particles (e.g., diamond or silicon carbide, to name a few). The portions of the cutting wire 107 spanning between the first and second wire guides 104 and 105 together form a multi-wire web 102. Segments of the cutting wire 107 in the multi-wire web 102 are referred to as “wires in the web.”

The wire 107 in the apparatus 100 shown in FIG. 1 has one end wound on a first spool 112 and the other end wound onto a second spool 114. In an alternative embodiment, the cutting wire 107 may be continuous (i.e., without ends). In such an alternative embodiment the spools 112 and 114 are not required. While this disclosure largely focuses on an embodiment having a single cutting wire 107 wrapped around the rotatable wire guides 104, 105, and 106 multiple times, in other embodiments, similar advantages can be achieved using more than one cutting wire 107.

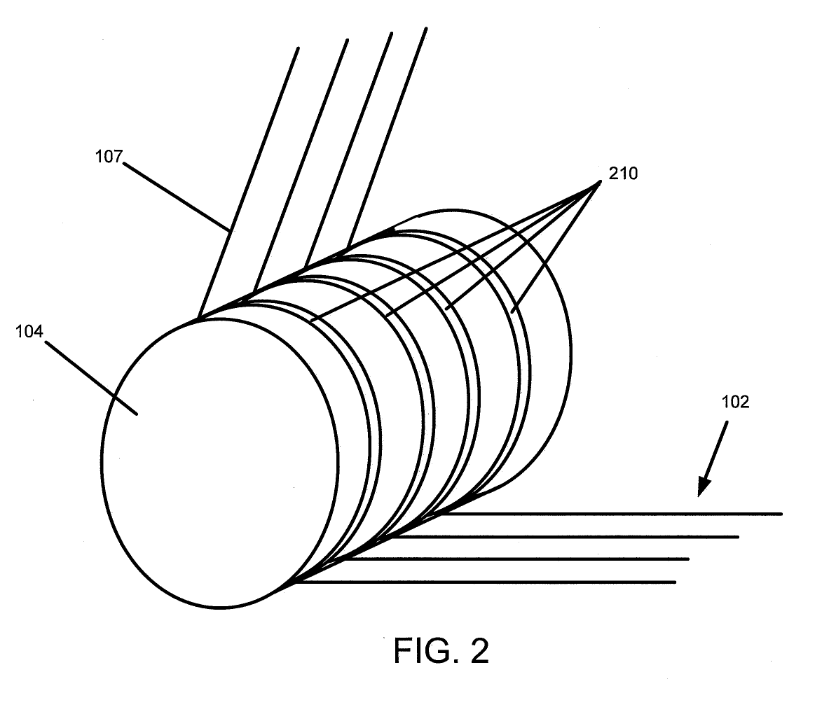

Although not fastened to the rotatable wire guides 104 and 105, the cutting wire 107 remains coupled to the rotatable wire guides via tension between the guides. For instance, and referring now to FIG. 2, the cutting wire 107 wraps around the lower left portion of the first rotatable wire guide 104 multiple times, a few of which are shown. Tension between the guides 104, 105 and 106 and the cutting wire 107 holds the cutting wire 107 taught against the rotatable wire guide 104.

The cutting wire 107 has cutting particles fixed to or embedded into its surface. These cutting particles are any particles of material suitable for being affixed to the cutting wire 107 and having a hardness (e.g., diamond or silicon carbide, to name a few) sufficient to cut through an ingot or block of semiconductor material such as silicon. Since a primary motivation for using slurry-free wire saws is to decrease the kerf width, cutting wire diameter is reduced as much as possible, and cutting particles having diameters less than about 100 microns are preferred. Preferably the diameter of the cutting particles is chosen to be between about 1-50 microns.

FIG. 2 is an enlarged view of one of the rotatable wire guides and portions of the multi-wire web shown in FIG. 1. The rotatable wire guides 104, 105, and 106 each has an exterior sleeve of resilient material such as a polymer. This sleeve has a series of wire grooves 210 formed on its surface to guide the wire 107. Wire grooves 210 have dimensions and shape allowing the cutting wire 107 to fit snuggly into the wire grooves 210 without substantial drag from the sides of the grooves. This allows the cutting wire 107 to fit into the grooves, to be held there via tension, yet prevent substantive lateral movement of the cutting wire 107. As the wires leave the guides, the guides themselves act a bit like picks that “pluck” the wire. This action sets the stage for web vibrations. The sizing of these grooves 210 has been found to be critical to minimization of wire web vibration. Thus the width of the guide grooves 110 must be chosen to minimize this action against the wire, but it is not entirely eliminated. The wires in the web 108 preferably remain equidistant from each other during saw operation such that the wafers cut by the multi-wire web 102 have uniform equal thickness (assuming no wire vibration).

A first drive mechanism 110 is coupled to the multi-wire web 102 via direct coupling to the first wire spool 112. The second end of the cutting wire 107 can be attached to the second wire spool 114. In the illustrated embodiment, the drive mechanism 110 imparts torque (rotational force) to the first wire spool 112, and a second drive mechanism 111 imparts torque to the second drive spool 114. A motor and a servo are non-limiting examples of drive mechanisms that can impart torque.

The first drive mechanism 110 is configured to drive the multi-wire web 102 across the semiconductor block or ingot 108 to cut wafers from the semiconductor ingot 108. By rotating the first wire spool 112 in a first direction, the cutting wire 107 is reeled in and wrapped around the first wire spool 112 while the cutting wire 107 is unwound from the second wire spool 114. When the first wire spool 112 is rotated in an opposite direction, cutting wire 107, wrapped around the first wire spool 112, is unwound, or reeled out, from the first wire spool 112, and reeled in by the second wire spool 114. In an alternative embodiment, not shown, the first drive mechanism 110 may be coupled to, and drive, the second wire spool 114. In an embodiment, there may be three or more wire spools. In other embodiments, one or more drive mechanisms may be directly coupled to one or more of the rotatable wire guides.

The wafer cutting apparatus 100 may have one or more movable tensioning pulleys (not shown). As it may be desirable to maintain a constant tension in the multi-wire web 108, one or more of the tensioning pulleys can be automatically adjusted to increase or decrease the tension applied to the web 108.

In FIG. 1 arrows indicate one of two directions that the cutting wire 107 can be driven in. The first drive mechanism 110 drives the first wire spool 112 clockwise, and in turn reels in the cutting wire 107 in the same fashion that a fishing reel pulls in fishing line. As the cutting wire 107 is reeled in by the first wire spool 112, the cutting wire 107 moves counterclockwise sequentially around the rotatable wire guides 104, 105, and 106. This movement also drives the rotatable wire guides 104, 105, and 106 counterclockwise.

Before the cutting wire 107 wrapped around the second wire spool 114 runs out, the drive mechanism 110 can reverse directions such that the second wire spool 114 begins to reel in the cutting wire 107 while the first wire spool 112 reels out the cutting wire 107. This direction reversal may be performed multiple times to cut through an ingot (e.g., when very wide-diameter wafers are being cut or when the length of cutting wire 107 is short). In other instances an entire wafer can be cut without the direction of cutting wire 107 travel being reversed.

In the embodiment illustrated in FIG. 1, the ingot 108 has a square brick or block profile. Other profiles and ingot shapes can also be cut using the systems, method, and apparatus herein disclosed. Some non-limiting examples of ingot shapes include a cube, a rectangular solid, a rectangular solid with beveled corners, or a cylinder, to name a few. It is also possible to cut more than one ingot at a time. For instance, ingots can be positioned side-by-side or end-to-end or in a combination of the two (e.g., a grid pattern).

In the illustrated embodiment, the ingot 108 moves up and through the multi-wire web 102. Alternatively, the multi-wire web 102 of the wafer cutting apparatus 100 may be moved downward and through the ingot 108. Further, both the ingot 108 and the multi-wire web 102 may be moved towards and through each other.

The ingot 108 may be made of any semiconductor material, although, at present, silicon is the predominant material for photovoltaic applications. Other non-limiting examples of semiconductor materials include germanium, gallium arsenide, gallium nitride, gallium phosphide, indium phosphide, aluminum gallium arsenide, and indium gallium arsenide, to name a few.

The wafer cutting apparatus 100 in accordance with the present disclosure includes a cleansing fluid 118 applied to the multi-wire web 102 during wafer cutting operation. The cleansing fluid 118 preferably comprises a major portion of water and a minor portion of surfactant. The surfactant (or surface acting agent) is a substance capable of reducing the surface tension of a liquid in which it is mixed with A surfactant may be soluble in both organic solvents and water. A surfactant may be an organic compound that contains molecules having hydrophobic and hydrophilic portions. The surfactant lubricates the cutting wire and extends cutting wire longevity. The surfactant also coats semiconductor particles cut from the semiconductor ingot. Consequently, the particles are unable to stick to the cutting wire, thus enabling the wire to be cleansed of particles. The coating attribute also prevents the silicon particles from oxidizing.

The surfactant may, for example, be a hydrotrope or a wetting agent. A hydrotrope is a substance that increases the solubility of another substance in solution. A hydrotrope may be organic. An anti-foaming agent is a substance that reduces foam formation in a liquid in which the agent is mixed. A defoamer is a substance that reduces the amount of foaming once foaming has occurred during saw operation. An anti-corrosive is a substance that reduces or prevents corrosion to materials that the anti-corrosive is in contact with. A biocide is a substance that kills specific organisms and reduces unwanted odors (e.g., chlorine).

The cleansing fluid may comprise one or more agents selected from the group consisting of: a hydrotrope, a wetting agent, an anti-foaming agent, an anti-corrosive, and a biocide. In one embodiment, the cleansing fluid comprises the following: a hydrotrope, a wetting agent, an anti-foaming agent, an anti-corrosive, and a biocide. These five substances in combination provide an effective anti-oxidizing coating for semiconductor particles. It has also been found that it is preferable to include both an anti-foaming agent and a defoaming agent in the cleansing fluid in order to keep foaming under control during saw operation.

Although the fluid disclosed herein has both lubricating and cleansing properties, for simplicity it will be referred to as a cleansing fluid. The cleansing fluid includes a surfactant to reduce the attraction between the particles and the wires. A water-based cleansing fluid, as disclosed herein, is easier to work with, cheaper to purchase, easier to recycle, and poses little to no risk to the environment compared to conventional fluids which are glycol-based and non-diluted. However, although the water-based cleansing fluid is less viscous than glycol-based lubricants, surface tension exerted by the fluid between wires in the web can pull some of these wires together. This can result in the thick-thin effect.

The undesirable effects of surface tension can be reduced or eliminated by application of the water-based cleansing fluid to the multi-wire web in an area close to the ingot. This minimizes the length of the multi-wire web affected by the surface tension of the fluid. The force of surface tension on the wires in the web is proportional to the length of the portions of the wires in the web that are wetted. By applying the cleansing fluid in close proximity to the kerf in the ingot, the length of wire that is wet outside the kerf is minimized. The force of surface tension can thereby be reduced to the point where adjacent wires in the multi-wire web are not pulled together and the thick-thin effect is avoided.

In FIG. 1, the cleansing fluid 118 is applied to the multi-wire web 102 via one or more cleansing fluid applicators 116. The cleansing fluid applicator is a device configured to apply cleansing fluid along a defined line, or area on the multi-wire web 102. The cleansing fluid applicator 116 applies the cleansing fluid to the multi-wire web close to the semiconductor ingot 108. Preferably the cleansing fluid 118 is applied in a laminar flow to the web 102 within about a 1-2 cm distance from the semiconductor ingot 108.

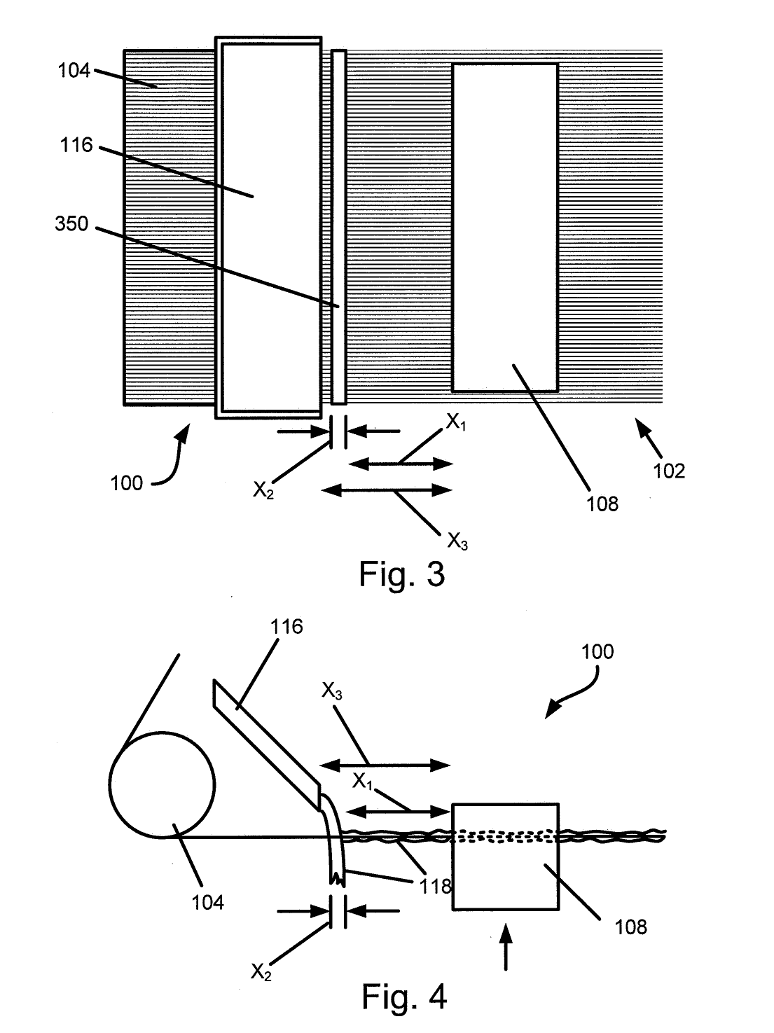

FIG. 3 illustrates a simplified overhead view of a portion of the wafer cutting apparatus of FIG. 1 showing a first rotatable wire guide, a cleansing fluid applicator 116, a region where the cleansing fluid falls on the multi-wire web, a multi-wire web 102, and a semiconductor ingot 108. FIG. 4 illustrates a simplified side view of the portion of the wafer cutting apparatus shown in FIG. 3.

The applicator 116 forms an elongated, generally flat bed trough that extends from front to back the length of the wire web 102 adjacent to the ingot 108. The approach angle of the ramped cleansing fluid applicator 116 affects the actual location where cleansing fluid 118 falls and contacts the multi-wire web 102 because of flow characteristics of the cleansing fluid being applied. The applicator 116 preferably includes a dispersion matting material along its length to ensure that the cleansing fluid flows in a laminar manner down the applicator 116 to the wire web 102 so as to minimize turbulent action in the fluid as the fluid contacts the wire 107 in the web 102. This helps to minimize any wire vibrations that may be introduced during operation of the apparatus 100. The applicator 116 is ramped to ensure laminar flow of the fluid so as to minimize turbulence at the wire-fluid interface and also because of space limitations within the saw geometry. Preferably the chosen configuration results in an application of fluid 118 in a laminar manner at a location within about 0.5-2 cm of the ingot 108 in order to minimize interference of fluid surface tension between adjacent wires in the web 102. This region has been found to be close enough to prevent inter-wire interaction and far enough to avoid detrimental fluid impact directly with the ingot 108.

For instance, in the illustrated embodiment, the discharge end of the cleansing fluid applicator 116 is positioned at a distance X₃ from the ingot 108, yet the cleansing fluid 118 touches the multi-wire web 102 at a distance X₁ from the ingot 108. These two distances can be varied by changing the discharge angle and position of the cleansing fluid applicator 116 and/or the fluid flow rate. The distance X₁ is measured from the front edge of the falling cleansing fluid 118 (not from the center of the falling cleansing fluid 118). The cleansing fluid applicator 116 is configured to apply the cleansing fluid 118 to an area, or region 350, of the multi-wire web 102 that extends parallel to the semiconductor ingot 108. The region 350 may have a width X₂ that depends on cleansing fluid 118 flow rate, air turbulence, and other factors. FIG. 4 further illustrates that some of the cleansing fluid 118 attaches to the multi-wire web 102 via surface tension and travels with the wires in the multi-wire web 102 as they pass into and through the kerfs in the ingot 108.

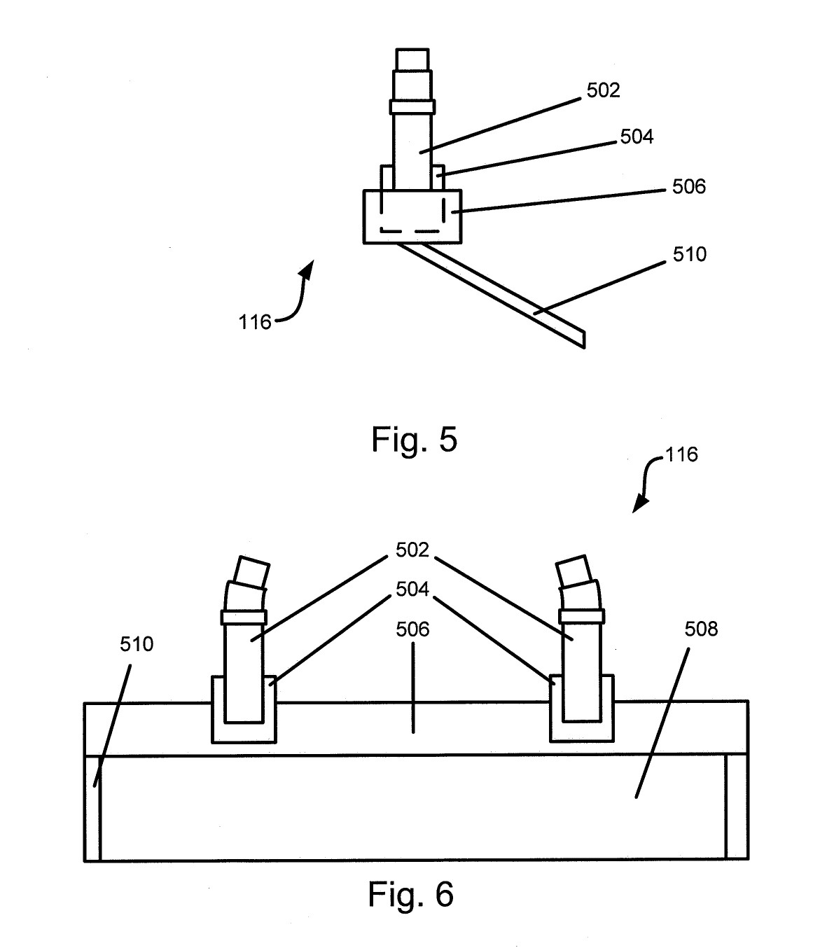

FIGS. 5 and 6 illustrate simplified side and front views, respectively, of an embodiment of a cleansing fluid applicator 116 used in the apparatus shown in FIG. 1. The cleansing fluid applicator 116 comprises a rectangular ramp 508, a fluid dispersal portion 506, and standard multi-wire delivery nozzle couplers 504. The cleansing fluid applicator 116 is fitted to one or more multi-wire delivery nozzles 502 via multi-wire delivery nozzle couplers 504. The standard multi-wire delivery nozzle couplers 504 facilitate transfer of fluid from the one or more multi-wire delivery nozzles 502 to the fluid dispersal portion 506.

Each of the ramps 508 has raised ramp side edges 510 to prevent cleansing fluid from flowing off the sides of the ramp 508. The fluid dispersal portion 506 is configured to spread the cleansing fluid from the one or more multi-wire delivery nozzles 502 uniformly across the surface of the ramp 508. A layer of dispersion matting (not shown) may be placed along the upper edge of the ramp 508 to ensure complete spreading of the fluid across the ramp 508. By spreading the cleansing fluid across the whole ramp 508, a substantially uniform flow, or laminar flow, of cleansing fluid can be created, and applied to every wire in the web 102 simultaneously at a uniform flow rate. Although the illustrated ramp 508 is rectangular, other shapes and sizes can also be used. For instance, the ramp 508 may be tapered with the portion closest to the semiconductor ingot 108 being narrower than the portion connected to the fluid dispersal portion 506.

### Multi-Wire Web Vibration Detection

As previously stated, the highest production of uniformly shaped and finished wafers requires operation of the wafer cutting apparatus 100 at an operating speed that minimizes wire vibration in the multi-wire web 102 during semiconductor ingot cutting. Determination of this optimal operating speed is preferably done using a multi-wire web vibration detector 120, positioned adjacent the multi-wire web 102, and configured to sense vibration of the multi-wire web 102. The vibration detector 120 preferably is an inductive vibration detector that does not require actual contact with the wire web 102. An exemplary vibration detector 120 may be a Humbucker, such as is typically utilized as a musical instrument sound detector. A Humbucker is a device that detects changes in an electromagnetic field using a pair of conductive coils having opposite polarities. Wire vibration creates changing magnetic fields (the cutting wire is made from a conductive material like steel), which in turn induces alternating currents in the Humbucker coils. These alternating currents may be sampled and recorded by a computer connected to the Humbucker as vibration amplitude data versus Humbucker coil position relative to the wire web. The amplitude of the induced current is generally proportional to the amplitude of vibration in the wires in the web.

The vibration detector 120 may alternatively be configured to detect changes in magnetic or electric fields by detecting optical or acoustical signals, or any other detection means that would indicate the amplitude of vibration in the multi-wire web 102. For instance, in another embodiment, the vibration detector 120 may comprise one or more optical sources (e.g., laser, LED, halogen light, incandescent light) along with one or more optical sensors (e.g., photodiode, photoresistor, photomultiplier, charge-coupled device, reverse-biased LED). In such an embodiment, the source projects light onto the multi-wire web 102 or any one or more of the wires in the web, and any reflected light is detected by the sensor. In another embodiment, an optical sensor may be configured to detect non-reflected and non-absorbed light projected through the multi-wire web 102 by an optical source. Although “optical” technically refers to the visible spectrum of light (i.e., approximately 380 nm to 750 nm), for the purposes of this disclosure, optical refers to any photonic wavelength (e.g., microwave, infrared, ultraviolet, to name a few). In another alternative embodiment, vibration detection could be performed via a hall sensor coupled to appropriate electronic signal processing equipment to resolve the web vibration data.

The vibration detector 120 is operably connected to a computer configured to receive, compile, and analyze the vibration amplitude data from the detector 120. For instance, as illustrated in FIG. 1, the vibration detector 120 is in communication with a computing device 122 via a communication line 124. The computing device 122 is configured to transform a signal from the vibration detector 120 into amplitude and frequency data representing the vibrations of the multi-wire web 102. For instance, the vibration detector 120 can detect vibrations in the multi-wire web 102, communicate this detected data to the computing device 122 via the communication line 124, and the computing device 122 can convert this data into vibration amplitude data as a function of frequency at a given drive speed. In another embodiment, the computing device 122 can convert this data into amplitude data without regard to frequency.

The computing device 122 can also display and/or store the data. The data can then be analyzed to determine and set an optimum operating speed for the wafer cutting apparatus 100. The vibration detector 120 and the computing device 122 may communicate through wired connection or wirelessly. The vibration detector 120 itself may alternatively store the data on an on-board memory module. The memory module is then transferred to a separate computing device 122 to undergo analysis. For the purposes of this disclosure a computing device includes a processor and memory for storing and executing program code, data, and software. Such computing devices may be provided with operating systems that allow the execution of software applications in order to manipulate data.

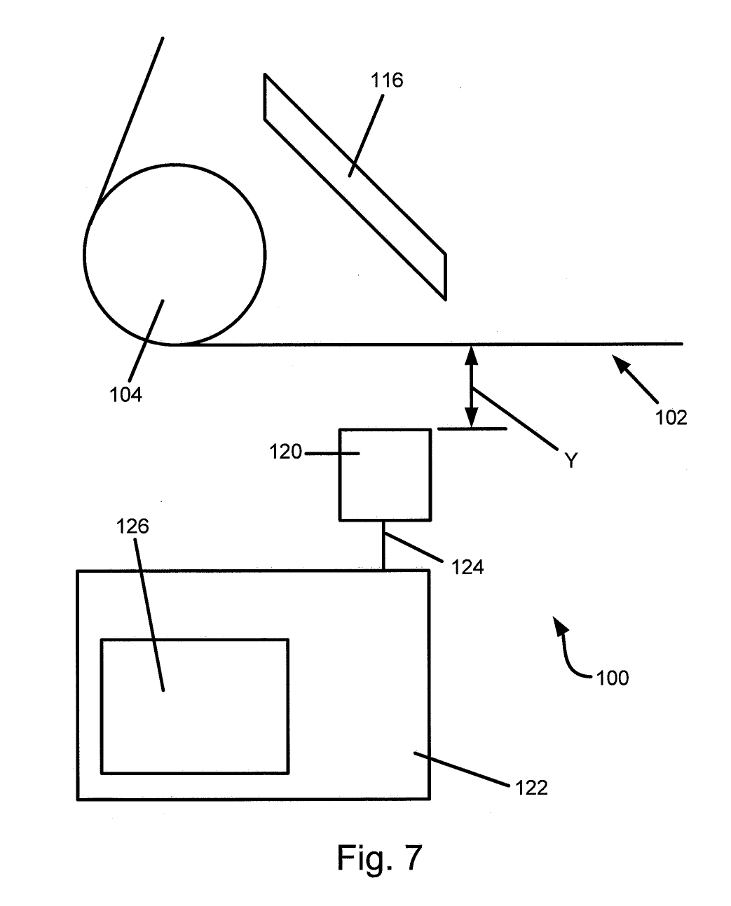

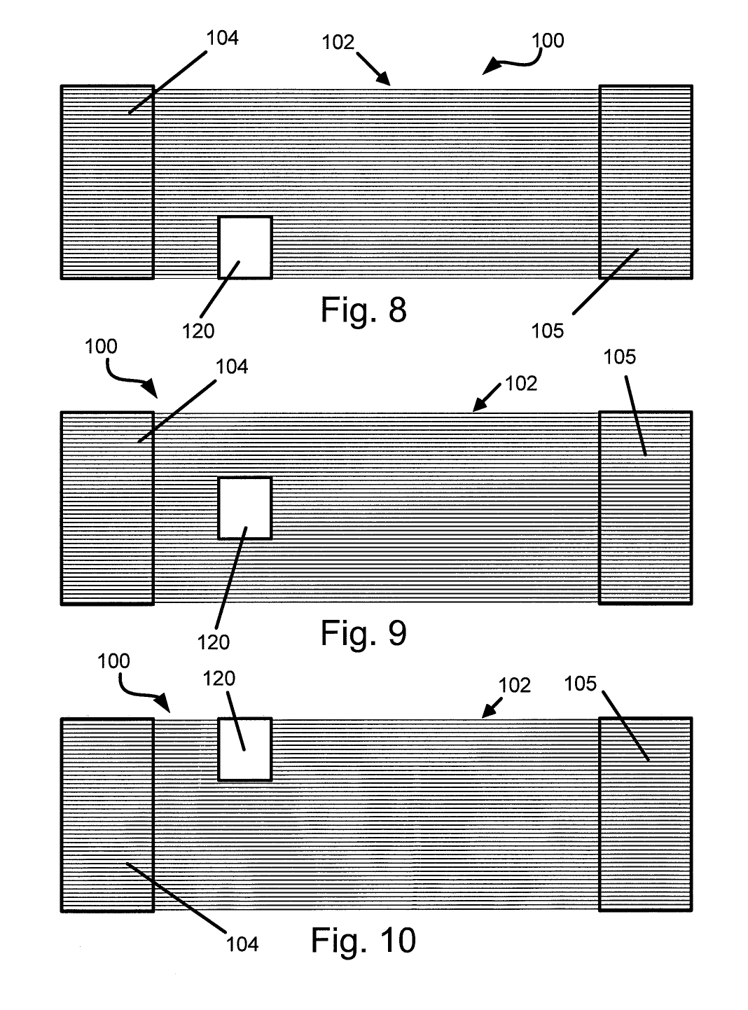

FIG. 7 illustrates a simplified detail view of a portion of the wafer cutting apparatus of FIG. 1 showing a vibration detector positioned a distance Y from the multi-wire web. FIGS. 8-10 show lateral positions of the detector 120 with respect to the wire web 102. The distance Y is any distance allowing vibration of the multi-wire web 102 to be detected. Thus, the distance Y may depend on the type of vibration detector 120 being implemented. The distance Y should not be so close that a wire 107 in the web comes into contact with the vibration detector 120 (unless the vibration detector 120 is one that detects vibration via physical contact with the multi-wire web 102). It is preferable that the detector be positioned consistently at a distance Y from the multi-wire web 102 regardless of the multi-wire web drive speed, and regardless of the lateral position of the vibration detector 120 (e.g., back, middle, or front of the multi-wire web 102 as shown in FIGS. 8, 9, and 10). When measuring vibrations at different multi-wire speeds in order to identify an optimum speed, the distance Y should remain unchanged. In an embodiment, the vibration detector 120 can be located a distance Y above or below the multi-wire web 102. In an embodiment where a Humbucker is used, the coils of the Humbucker may be oriented such that an axis through the center of the coils is perpendicular to a plane created by the multi-wire web 102.

As mentioned above, a goal of the method, and apparatus herein described is to determine an optimum speed to drive the multi-wire web 102 at (i.e., the speed at which multi-wire web vibration is minimized). This can be determined by monitoring multi-wire web vibration as a function of multi-wire web speed, and selecting the speed corresponding to the lowest vibrations as the optimum multi-wire web speed.

Specifically, this determination can be performed by setting the multi-wire web speed to a first speed, detecting vibration of the multi-wire web, generating vibration data from the detected vibration of the multi-wire web, repeating the setting, detecting and generating operations for a plurality of multi-wire web speeds, identifying the multi-wire web speed having a lowest vibration, and then operating the apparatus 100 at the speed having the lowest vibration This is the optimum speed for cutting operations.

Surprisingly, the ingot 108 need not be present on the apparatus 100 during determination of the optimum driving speed. The optimum speed may be determined by displaying the vibration data on a display and allowing a user to identify the optimum speed. An algorithm 126 may be used by the computing device 122 to automatically analyze the vibration data and determine the optimum speed. Once an optimum speed is determined, the multi-wire web 102 can cut an ingot using the optimum speed. During cutting, the vibration detector 120 also need not be present.

In an embodiment of the apparatus 100 according to this disclosure, the operations of detecting vibrations, identifying an optimum speed, and driving the cutting wire 107 at the optimum speed can be fully or partially automated. For instance, the vibration detector 120 may be used to detect wire vibrations while the multi-wire web 102 cuts an ingot. The algorithm 126 could instruct one or more drive mechanisms 110 and 111 to drive the cutting wire 107 at a plurality of speeds. Vibration data recorded at each of these speeds could be analyzed by the computer 122 and an optimum speed identified. The algorithm 126 may then instruct the one or more drive mechanisms 110 and 111 to drive the cutting wire 107 at the optimum speed.

To automatically identify and set an optimum speed, or to do so dynamically, the computing device 122 may be in communication with the first drive mechanism 110 and/or the second drive mechanism 111. The computing device 122 may instruct either or both drive mechanisms 110 and 111 to drive the cutting wire 107 at the optimum speed or the new optimum speed.

FIGS. 8, 9, and 10 are simplified partial overhead views of the multi-wire web 102 of the wafer cutting apparatus 100 as in FIG. 1 showing the vibration detector 120 locations at front, middle, and back positions, respectively. Testing has shown that the vibration of the wires across the web at different locations in the multi-wire web 102 (e.g., front, middle, and back) is not the same. Vibration appears to be greatest near the front (bottom of FIGS. 8, 9, and 10) and back (top of FIGS. 8, 9, and 10) of the multi-wire web 102, while vibration is least near the middle of the multi-wire web 102. The optimum speed may be determined by analyzing the vibrations measured at two or more locations on the multi-wire web 102 and at a variety of drive speeds, as permitted by the drive configuration of the apparatus 100. It should be noted that the vibration detector 120 is not limited to the three illustrated positions. These are merely representative locations.

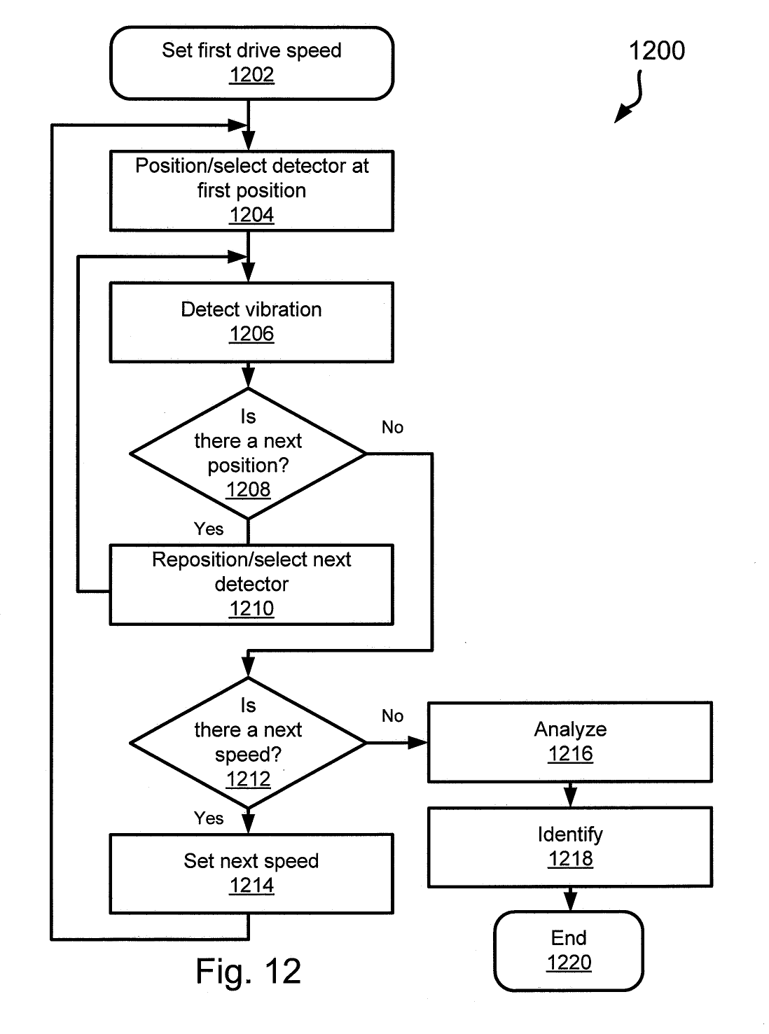

FIG. 12 is a representative process flow diagram of one exemplary method 1200 for determining the optimal speed of operation for a wafer cutting apparatus 100 in accordance with the present disclosure. This is an iterative method which can be performed manually or automatically via computer control. In the illustrated diagram, this process could be implemented via software control of the apparatus 100.

The method, or process 1200 begins in operation 1202. In operation 1202, the wafer cutting apparatus 100 drive mechanism 110 (or 111) is set at a first multi-wire web speed. This may be accomplished either manually or automatically (e.g. via computer instruction). As an example, this first speed may be set to 13 meters per second. Next, the vibration detector 120 is positioned at a first position in operation 1204, and the saw operated at that designated speed. Control, either manual or automatic, then transfers to operation 1206.

In operation 1206, vibration in the multi-wire web 102 is detected and vibration data stored for analysis. Control then transfers to query operation 1208.

Query operation 1208 asks whether there is a next detector selection or position required. If so, control transfers to operation 1210 in which the detector 120 position is changed, or next detector 120 selected, for example, from that shown in FIG. 8 at the position shown in FIG. 9. If there is no next detector or next detector position required, then control transfers to query operation 1212.

In query operation 1212, the query is made whether there is a next multi-wire web speed to be utilized. If the answer to this query is yes, then control transfers to operation 1214. Operation 1214 requires that the next multi-wire web speed be established or set. Once established, control transfers back to operation 1204 and operations 1204 through 1212 are repeated in order to measure the vibration levels at this next speed.

If the answer in query operation 1212 is no, then control transfers to operation 1216. In operation 1216, the vibration data collected in detection operation 1206 is analyzed. Operation 1216 is preferably carried out by algorithm 126 in the computer 122. The algorithm 126 determines the amplitude of vibration for a given multi-wire web speed based on the vibration data collected in detection operation 1206. This may be done independent of vibration frequency. Alternatively, the algorithm 126 may determine the fundamental frequency and harmonics of the fundamental frequency for each wire speed measured. This determination utilizes the classical formula for fundamental frequency of a vibrating wire, which is:

$$f = \frac{1}{2} \cdot L \cdot \sqrt{\frac{T}{M}}$$

where f=fundamental frequency, L=unconstrained wire length, T=wire tension, and M=wire mass. The amplitude of vibration may then be determined for the fundamental frequency and harmonics of the fundamental frequency relative to each multi-wire web speed. Whether amplitude is determined independent of frequency or not, control then transfers to operation 1218 where the lowest vibration operating speed (the optimal speed) is identified and selected.

Once the optimal speed is identified and selected, control transfers to end operation 1220. This completes the determination of the optimum speed, and hence the speed at which the wafer cutting apparatus 100 should be operated. In one embodiment, the optimum speed may be automatically provided to the drive mechanism 110, and optionally 111, enabling them to operate at the optimum speed. Otherwise, this optimum speed may be manually set on the apparatus 100.

In one embodiment of the apparatus 100, the above process 1200 is performed by manually positioning the vibration sensor 120 and manually controlling operation of the apparatus 100 at the various speeds. In another embodiment the process 1200 may be partially or completely automated and computer controlled via computer 122. In such an embodiment, the speed of apparatus 100 may be automatically set based on the identified optimum speed determined in operation 1218.

In an alternative embodiment, the vibration detector 120 may be an assembly configured large enough to physically span across the length of the entire multi-wire web 102, with one or more separately addressable detectors 120 housed therein. In this case, selection of the active vibration detector 120 would be electronically controlled, thus not requiring physical repositioning of the detector 120 as in FIGS. 8-10. In a still further alternative embodiment, the vibration detector 120 could simply remain in a fixed location, for example, adjacent the front portion of the multi-wire web 102 as shown in FIG. 8. In such an alternative, the answer in query operation 1208 would always be “no” as no repositioning (or selection of a different detector 120) would be needed.

In a fully automated version of the wafer cutting apparatus 100, dynamic measurement and control of web vibration would be very advantageous. Dynamic vibration measurement could be used to ensure that variations in such things as cleansing fluid concentration and silicon particle buildup on the cutting wire 107 are dynamically compensated for by changes in the drive speed and/or tension in the multi-wire web 102.

A major consideration when cutting silicon wafers is the high cost of material lost as part of the kerf (silicon prices were as high as $350 per kilogram in October 2008). Available slurry-free cutting wires have diameters as small as 140 microns and 125 microns (the 125 micron cutting wire being less reliable at this time). Silicon wafers for solar applications are around 180 microns thick. Thus, even when cutting with cutting wires as thin as 140 microns, around 40% of the ingot is removed from the kerf and turned into silicon particles that are now being thrown away.

While methods for recycling these particles into fresh silicon ingots are known, there is a major problem when using a water based cleansing fluid in a slurry-free saw. When dealing with very small, micron-sized silicon particles, the native oxide layer converts most of the surface and a large portion if not the entire particle into silicon dioxide, thus rendering the particles non-recyclable.

To solve this problem the surfactant provided by the present disclosure in the water-based cleansing fluid 118 envelopes the silicon particles as soon as they are ripped (cut) from the silicon brick or ingot 108 during the cutting process. As a result, oxygen in the water is effectively precluded from reaching the silicon itself. The surfactant in the cleansing fluid 118 not only helps to minimize surface tension in the fluid, flush particles from the kerf, and prevent particle adhesion to the cutting wire, it has the added advantage of preventing silicon oxidation. The silicon particles can then be transported to a remote recycling facility or moved to an on-site recycling system without first having been oxidized. As a result, the silicon can actually be reclaimed for later reconstruction into silicon ingots or bricks.

In a slurry-free wire saw such as the wafer cutting apparatus 100, silicon particles created by the cutting process tend to stick to the cutting wire. These particles can cause vibration in the web 102 that can lead to wire jump and/or ingot fracture or breakout. The cleansing fluid 118 removes a significant fraction of these particles from the multi-wire web 102. The surfactant in the cleansing fluid of this disclosure envelopes the silicon particles and precludes air and water from reaching the silicon. As such, the silicon particles can be separated and fed into a fresh silicon ingot manufacturing process. The silicon particles can be recycled in an on-site system or transported to an off-site facility for such a purpose.

One exemplary cleansing fluid 118 includes ingredients as is shown in the following table:

| Type | Description | Trade Name | Weight % |
|---|---|---|---|
| Deionized Water | Deionized Water | DIWater | 76.85 |
| surfactant | linear alkoxylated | Chemal LFL-28C | 7.10 |
| | alcohol | | |
| hydrotrope (and | phosphate ester | Triton H-66 | 3.55 |
| surfactant) | | | |
| antifoam | polydimethylsiloxane | SAG 2001 | 6.00 |
| defoam | fatty acid ester | DFO-133 | 6.00 |
| corrosion resistor | fatty amine ethoxylate | PT-10T | 0.50 |
| corrosion resistor | hydroxy ethylidene | HEDP | 0.002 |
| | diphosphonic acid | | |
| | | TOTAL | 100.00 |

An exemplary cleansing fluid as prepared in the proportions shown is a concentrate. The concentrate is then added at about a 3% proportion into water to make up the mixture for use in a saw in accordance with this disclosure. It is to be understood that the above cleansing fluid is merely exemplary. Other compositions may alternatively be utilized in accordance with the teachings of this disclosure as above described. These constituents are available commercially in the United States. For example, Chemal LFL-28C, PT-10T, and DFO-133 are available from PCC Chemax, of Piedmont, S.C. Triton H-66 is available from Dow Chemical Co. SAG 2001 is available through Momentive Performance Materials, Inc., Wilton Conn. Finally, HEDP is available through Mid South Chemical Company, Inc., Ringgold, La.

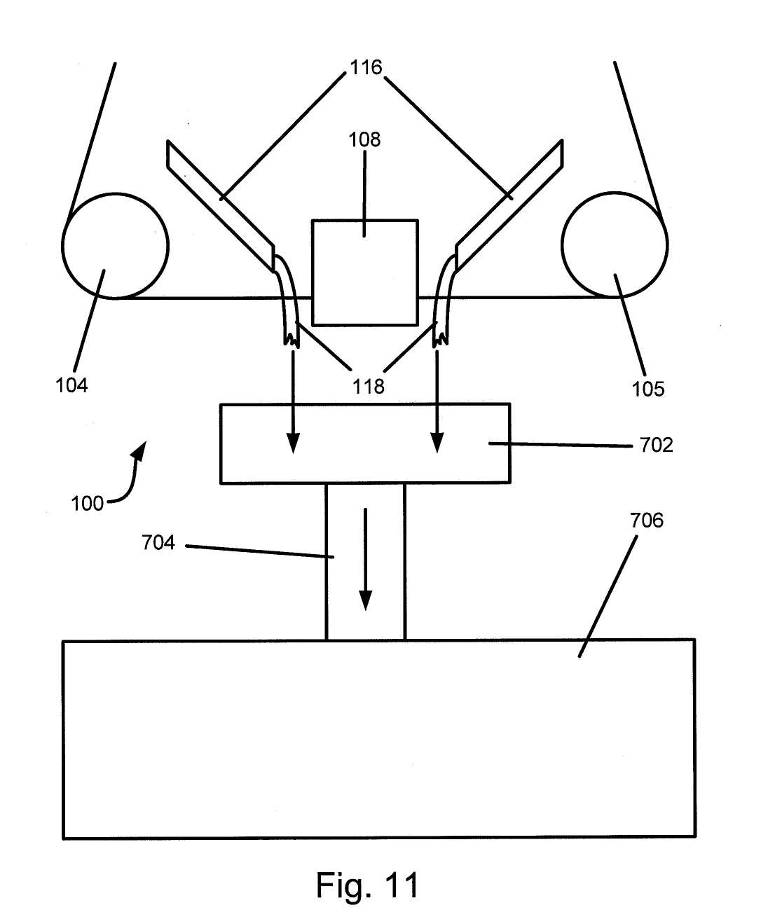

FIG. 11 illustrates a simplified view of an embodiment of a wafer cutting apparatus including a cleansing fluid collector used in the apparatus shown in FIG. 1. The cleansing fluid collector 702 stores (for either a short or long period of time) the cleansing fluid 118 along with the silicon particles dispersed in the cleansing fluid 118. Cleansing fluid 118 is transferred from the cleansing fluid collector 702 to the transport vessel 706 via a fluid transport apparatus 704. The transport apparatus 704 may be passive thus relying on gravity or liquid pressure to transfer the cleansing fluid 118 from the cleansing fluid collector 702 to the transport vessel 706. Alternatively, the transport apparatus 704 may include a pump to facilitate transfer of the cleansing fluid 118 from the cleansing fluid collector 702 to the transport vessel 706.

Neither the transport apparatus 704 nor the transport vessel 706 are required components. For instance, the cleansing fluid collector 702 may be transported to a facility where silicon separation and recycling take place. Alternatively, the cleansing fluid 118 may be separated into the silicon particles and clean cleansing fluid on-site, and the clean cleansing fluid 118 returned to the cleansing fluid applicators 116. In an embodiment, a single recycling device can perform all three aspects of the recycling system: collect cleansing fluid 118 from the ingot 108 containing semiconductor particles, separate the semiconductor particles from the fluid 118, return the clean cleansing fluid 118 to the cleansing fluid applicators 116, and consolidate the separated particles into a form for further processing.

Finally, optimal operation of a wire saw 100 in accordance with the present disclosure preferably involves utilization of three features of this disclosure together: detection and operation of the apparatus 100 at optimum speed to minimize wire vibration; application of a water based cleansing fluid containing a surfactant to the wire web; and application of the cleansing fluid within about 2 cm of the ingot 108 during cutting operation. Further, the cleansing fluid in the present disclosure may advantageously be recycled to recover silicon particles and reconstitute the silicon into ingots, blocks or bricks without significant formation of silicon dioxide which cannot be practically recycled.

While various embodiments of the present disclosure have been described in detail, modifications and adaptations of those embodiments will occur to those skilled in the art. For example, while the described embodiments of the vibration detector detect without physically contacting the multi-wire web 102, in an embodiment, the vibration detector used could detect via physical contact with a structure in contact with the multi-wire web 102 such as one of the guides 104 or 106. The described embodiments involve a wafer cutting apparatus that has a single cutting wire 107. Alternatively the embodiments of this disclosure may be utilized with any multi-wire web sawing apparatus to optimize saw operation. Further, slurry saw configurations may be modified to operate without the use of a slurry in accordance with this disclosure.

Other configurations of Humbuckers or other induction vibration sensors may also be utilized. For example, there may be three or more Humbuckers 120 arranged in a housing spanning the front, mid portion and rear portions of the web. In such an embodiment, rather than moving the Humbucker 120 to a different position, a different Humbucker 120 would simply be electrically selected in the procedure described in FIG. 12 that corresponds to the desired detector position.

Additionally, the silicon recycling system is not limited to silicon recycling. One skilled in the art will recognize that the recycling system can be used to recycle particles generated from the cutting of any material including non-silicon semiconductor materials. It is to be expressly understood that such modifications and adaptations are within the spirit and scope of the present invention as defined by the appended claims.

What is claimed is:

1. A wafer cutting apparatus configured to simultaneously cut a plurality of wafers from a block or ingot of semiconductor material, the apparatus comprising:
(a) two or more rotatable wire guides rotatably mounted on a frame;
(b) a cutting wire impregnated with a plurality of cutting particles wrapped multiple times around the two or more wire guides and forming a multi-wire web spanning between two of the two or more rotatable wire guides;
(c) a drive mechanism fastened to the frame and coupled to cutting wire, and configured to drive the multi-wire web across an ingot to cut wafers from the ingot at an optimum speed determined by setting a multi-wire web speed to an initial speed, detecting vibration of the multi-wire web, generating vibration data from the detected vibration of the multi-wire web, repeating the setting, detecting and generating operations for a plurality of multi-wire web speeds different from the initial speed, identifying the multi-wire web speed having a lowest vibration, and operating the drive mechanism at the speed having the lowest vibration as the optimum speed;
(d) a cleansing fluid including a major portion of water and a minor portion of surfactant; and
(e) one or more cleansing fluid applicators configured to apply the cleansing fluid to the multi-wire web within a 2 cm distance or less from the ingot as the multi-wire web is driven to cut the plurality of wafers from the semiconductor ingot.

2. The wafer cutting apparatus of claim 1 wherein the cleansing fluid includes one or more agents selected from the group consisting of an anti-foaming agent, a defoaming agent, an anti-corrosive, and a biocide.

3. The wafer cutting apparatus of claim 2 wherein the cleansing fluid includes a wetting agent.

4. The wafer cutting apparatus of claim 1 wherein the vibration of the multi-wire web is detected with a Humbucker positioned adjacent a portion of the multi-wire web.

5. The wafer cutting apparatus of claim 1 further comprising a recycling device configured to collect cleansing fluid containing semiconductor particles from the ingot, separate the semiconductor particles from the fluid, and return the cleansing fluid to the cleansing fluid applicators.

6. The wafer cutting apparatus of claim 1 wherein the cutting particles are diamond.

7. The wafer cutting apparatus of claim 1, wherein the cleansing fluid applicators include ramps.

8. The wafer cutting apparatus of claim 1, wherein the applicators are configured to apply the cleansing fluid to the multi-wire web within 1.5 cm of the semiconductor.

9. The wafer cutting apparatus of claim 1, wherein the applicators are configured to apply the cleansing fluid to the multi-wire web within 1.0 cm of the semiconductor ingot.

10. The wafer cutting apparatus of claim 1 wherein the vibration data is vibration amplitude data.

11. The wafer cutting apparatus of claim 1, wherein the optimum speed is determined by use of an inductive vibration detector positioned adjacent the multi-wire web, wherein the detector is operably connected to a computer configured to analyze the vibration amplitude data.

12. The wafer cutting apparatus of claim 1, wherein the cleansing fluid has one or more agents selected from the group consisting of: a hydrotrope; a wetting agent; an anti-foaming agent; a defoaming agent, an anti-corrosive; and a biocide.

13. The wafer cutting apparatus of claim 11, further comprising a recycling device configured to collect cleansing fluid discharged from the ingot containing semiconductor particles, separate the semiconductor particles from the fluid, and return the cleansing fluid to the cleansing fluid applicators.

14. The wafer cutting apparatus of claim 12 wherein detecting vibration of the multi-wire web is performed by a vibration detector configured to sense vibration of the multi-wire web communicating with a computer configured to transform a signal from the detector into amplitude data representing the vibrations of the multi-wire web.

15. The wafer cutting apparatus of claim 13 wherein the vibration detector is an inductive vibration detector positioned adjacent to the multi-wire web.

16. A method for determining an optimal operating speed for a multi-wire web wafer cutting apparatus comprising:
setting a multi-wire web speed to a first multi-wire web speed;
detecting vibration amplitude in the multi-wire web using a vibration detector positioned in proximity to a portion of the multi-wire web;
generating vibration amplitude data from the detected vibration amplitude of the multi-wire web;
repeating the setting, detecting, and generating operations for a plurality of multi-wire web speeds;
assessing the vibration amplitude data for each of the plurality of multi-wire web speeds;
identifying the multi-wire web speed having the lowest vibration amplitude as the optimum operating speed.

17. The method of claim 16 wherein the vibration detector comprises an induction vibration sensor positioned adjacent the portion of the multi-wire web.

18. The method of claim 16 wherein the detector is a Humbucker positioned adjacent the portion of the multi-wire web.

19. A method of preventing silicon dioxide formation in particles generated by a wafer cutting apparatus configured to simultaneously cut a plurality of wafers from a silicon block or ingot, the apparatus having two or more rotatable wire guides, a cutting wire impregnated with a plurality of cutting particles wrapped multiple times around the two or more wire guides and forming a multi-wire web spanning between two of the two or more rotatable wire guides, and a drive mechanism coupled to cutting wire configured to drive the multi-wire web across the ingot to cut wafers from the ingot, the method comprising:
operating the drive mechanism at an optimum speed; and
applying a water based cleansing fluid to the multi-wire web, the cleansing fluid having a major portion of water and a minor portion of a surfactant, wherein the cleansing fluid includes one or more agents selected from the group consisting essentially of a hydrotrope; a wetting agent;
an anti-foaming agent; a defoaming agent, an anti-corrosive; and a biocide.

20. The method of claim 19 wherein the optimum speed is determined by:
setting a multi-wire web speed to a first speed, detecting vibration of the multi-wire web, generating vibration data from the detected vibration of the multi-wire web, repeating the setting, detecting and generating operations for a plurality of multi-wire web speeds different from the first speed, identifying the multi-wire web speed having a lowest vibration, and operating the drive mechanism at the speed having the lowest vibration as the optimum speed.
